(19) United States
(12) Patent Application Publication
(10) Pub. No.: US 2017/0058954 A1
(43) Pub. Date: Mar. 2, 2017

(54) SHAFT SEAL HAVING TRANSITIONAL CONTACT

(71) Applicant: Lincoln Industrial Corporation, St. Louis, MO (US)

(72) Inventor: Paul G. Conley, St. Charles, MO (US)

(21) Appl. No.: 14/833,766

(22) Filed: Aug. 24, 2015

(51) Int. Cl. F16C 33/72; F16J 15/16; F16C 33/76; F16C 35/04; F16C 19/28; F16C 33/66

(52) U.S. Cl. CPC F16C 33/723; F16C 19/28; F16C 33/66; F16C 33/76; F16C 35/042; F16J 15/16

(57) ABSTRACT

A bearing assembly including a housing, a bearing, and a shaft in the bearing. The assembly includes a seal mounted in the housing and around the shaft. The seal has an inner surface having a tapered portion spaced from the shaft by a clearance gap having a predetermined axially varying width. The width of the gap decreases from a bearing side toward an opening side. The inner surface includes an axially extending sealing portion having an inner diameter corresponding to the shaft and forming a sealing interface. The interface supports tribological film lubrication when the shaft rotates relative to the housing to reduce shaft wear and contacts the shaft when the shaft is stationary relative to the housing to prevent contaminants from entering the interior cavity of the housing through the interface.

### BACKGROUND

The present invention generally relates to a seal, and more particularly, to a non-contact seal surrounding a rotating shaft that contacts the shaft when stationary.

Conventional bearing assemblies include a housing, a bearing mounted in the housing, and a shaft mounted in the bearing for rotation relative to the housing. Seals are provided between the housing and shaft to prevent contaminants outside the housing from entering the housing and damaging the bearing. As will be appreciated by those skilled in the art, relative motion occurs between the seal and the shaft, causing wear. In order to reduce seal wear, a small gap or clearance is provided between the seal and the shaft so the seal and the shaft do not contact as the shaft turns in the seal. This reduces seal wear and increases the life of the bearing assembly.

Lubricant is introduced into the housing of the bearing assembly to reduce wear and friction between the moving parts. During operation, the lubricant in the housing is pressurized to prevent contaminants from entering the housing through the clearance where the contaminants could damage the bearing and reduce bearing life. During shutdown when the shaft is stationary, lubricant pressure drops, permitting contaminants to enter the housing through the clearance provided in conventional assemblies. Further, when the assembly is splashed with water such as when washed, water can enter the bearing assembly through the clearance, potentially causing bearing damage and reducing life. Although non-metallic seals have been introduced, these seals have limited wear resistance and temperature capabilities. Thus, there is a need for seals that permit lubricant to enter the gap between the seal and shaft as the shaft rotates, but that fully contacts the shaft when stationary to prevent contaminants and water from entering the bearing assembly.

### SUMMARY

In one aspect, the present disclosure includes a bearing assembly, comprising a housing having an interior cavity adapted to hold a lubricant. The housing also has an opening extending from the interior cavity to an exterior of the housing, an inward facing seal mounting surface, and an inward facing bearing seat. The bearing assembly also includes a bearing positioned in the interior cavity of the housing. The bearing has a central axis, as well as, an outer race mounted in the inward facing bearing seat of the housing and an inner race centered on the central axis and freely rotatable in the outer race. Further, the bearing assembly includes a shaft mounted in the inner race of the bearing for rotation with the inner race about the central axis of the bearing. The shaft has an outer surface extending along the shaft from the interior cavity through the opening to the exterior of the housing. At least part of the outer shaft aligned with the opening has a sealing diameter. The assembly includes a seal mounted in the seal mounting surface of the housing and around the outer surface of the shaft. The seal is positioned axially along the shaft between the interior cavity of the housing and the exterior of the housing to inhibit contaminants from entering the interior cavity of the housing through the opening and damaging the bearing. The seal includes an annular body having a bearing side facing the bearing, an opening side opposite the bearing side, and an inner surface facing the outer surface of the shaft. The inner surface has a tapered portion spaced from the outer surface of the shaft by a clearance gap having a predetermined axially varying width. The width of the clearance gap decreases from the bearing side toward the opening side. The inner surface also includes an axially extending sealing portion having an inner diameter corresponding to the sealing diameter of the outer surface of the shaft and forming a sealing interface with the outer surface of the shaft. The interface supports tribological film lubrication when the shaft rotates relative to the housing to reduce shaft wear. Further, the seal contacts the shaft when the shaft is stationary relative to the housing to prevent contaminants from entering the interior cavity of the housing through the interface.

In another aspect, the present disclosure includes a seal for use in a bearing assembly having a housing, a bearing positioned in the housing, a shaft mounted in the bearing for rotation and having a radially outward facing surface extending through an opening in the housing. The seal comprises an annular body having a bearing side adapted for facing the bearing when installed in the bearing assembly. The body has an opening side opposite the bearing side and an inner surface facing the outer surface of the shaft. The inner surface has a tapered portion spaced from the outer surface of the shaft by a clearance gap having a predetermined axially varying width. The width of the clearance gap decreases from the bearing side toward the opening side. The inner surface also includes an axially extending sealing portion having an inner diameter corresponding to the sealing diameter of the outer surface of the shaft and forming a sealing interface with the outer surface of the shaft. The interface supports tribological film lubrication when the shaft rotates relative to the housing to reduce shaft wear and contacts the shaft when the shaft is stationary relative to the housing to prevent contaminants from entering the interior cavity of the housing through the interface.

In still another aspect, the present disclosure includes a seal for use in a bearing assembly having a housing, a bearing positioned in the housing, a shaft mounted in the bearing for rotation and having a radially outward facing surface extending through an opening in the housing. The seal comprises an annular body having a bearing side adapted for facing the bearing when installed in the bearing assembly and an opening side opposite the bearing side. Further, the annular body includes a radial section extending between an inner boundary and an outer boundary. The body also includes an outer axial section extending axially from the outer boundary of the radial section and an inner axial section extending axially from the inner boundary of the radial section. The inner axial section has an inner surface adapted for facing the shaft when installed in the bearing assembly. The inner surface includes a tapered portion having a predetermined axially varying radius, the radius decreasing from the bearing side toward the opening side The inner surface also includes an axially extending sealing portion having an inner diameter corresponding to the sealing diameter of the outer surface of the shaft and forming a sealing interface with the outer surface of the shaft. The interface supports tribological film lubrication when the shaft rotates relative to the housing to reduce shaft wear and contacts the shaft when the shaft is stationary relative to the housing to prevent contaminants from entering the interior cavity of the housing through the interface.

Other objects and features will be in part apparent and in part pointed out hereinafter.

### BRIEF DESCRIPTION OF THE DRAWINGS

FIG. 1 is a perspective of a bearing assembly of a first embodiment;

FIG. 2 is a separated perspective of the bearing assembly of FIG. 1;

FIG. 3 is a cross section of the bearing assembly of FIG. 1;

FIG. 4 is a perspective of a seal of the bearing assembly of FIG. 1;

FIG. 5 is a cross-sectional elevation of the seal of the bearing assembly of FIG. 1;

FIG. 6 is detail of a portion of FIG. 3; and

FIG. 7 is an exemplary graph illustrating frictional characteristics of lubricant film formed between the shaft and the seal.

Corresponding reference characters indicate corresponding parts throughout the drawings.

### DETAILED DESCRIPTION OF THE DRAWINGS

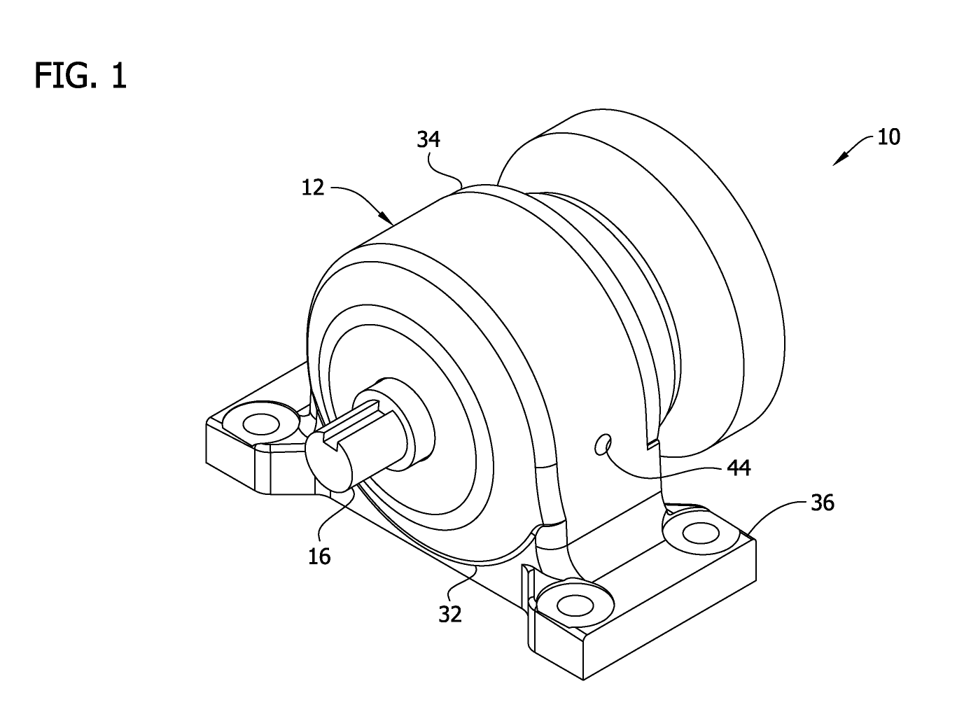

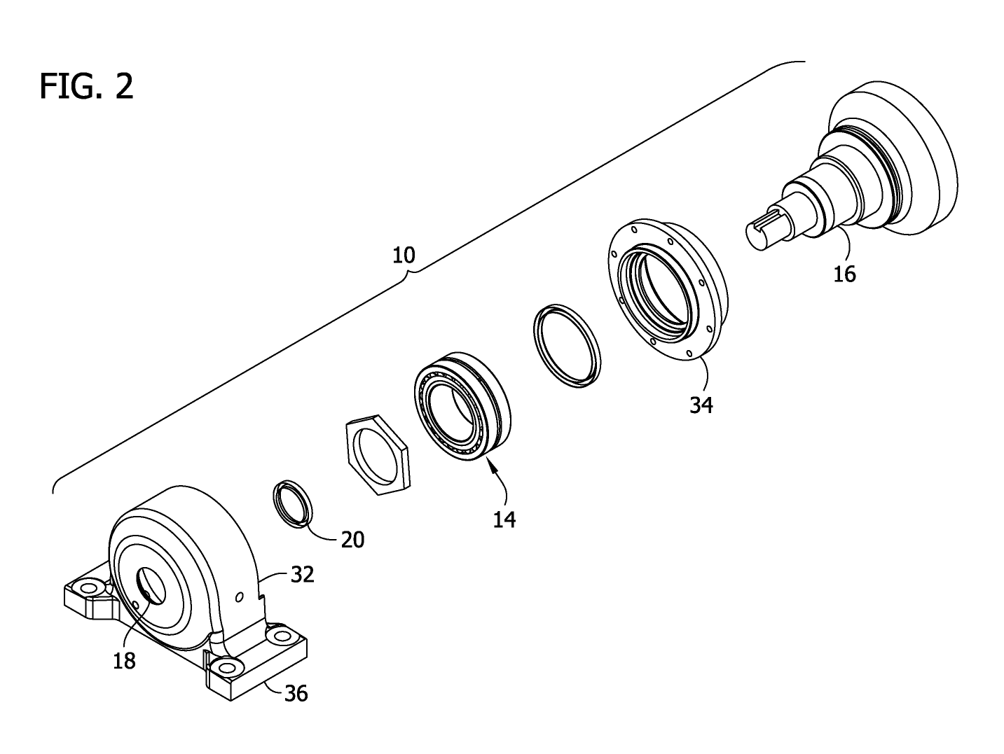

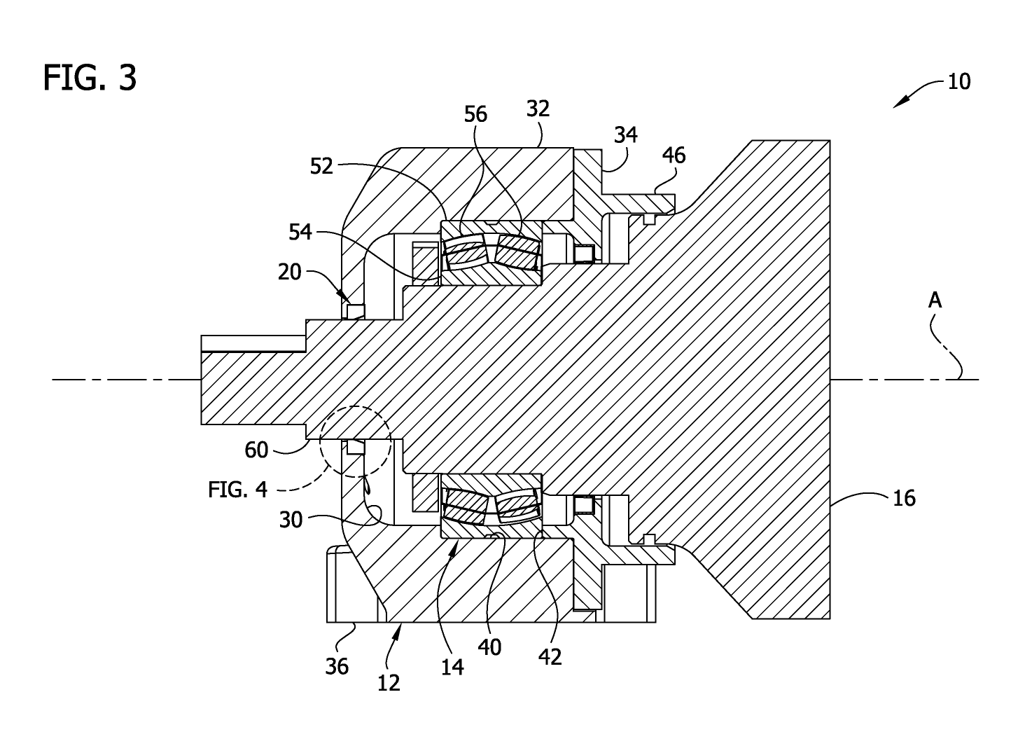

Referring to FIGS. 1-3, a bearing assembly is generally indicated in its entirety by reference number 10. The bearing assembly 10 includes a housing (generally designated by 12) supporting a bearing (generally designated by 14) (e.g., a double row spherical roller bearing as shown in FIGS. 2 and 3). The housing 12 is suitably configured to be mounted in a mechanical apparatus (not shown) to support a shaft 16 for rotation. The shaft 16 is mounted in the bearing 14 to rotate relative to the housing 12. A free end of the shaft 16 extends through an opening 18 in the housing 12 to operatively connect to a rotating part in the mechanical apparatus. A seal, generally designated by 20, is positioned on the shaft 16 adjacent to the opening 18 to inhibit contaminants from entering the housing 12 through the opening and damaging the bearing 14. As will be explained below, the seal 20 effectively inhibits the ingress of contaminants into the housing 12 when the shaft 16 is stationary and permits lubricant to wet an interface between the seal 20 and the shaft 16 when the shaft is rotating to reduce wear and extend part life. As will be appreciated, the seal 20 may be used in a bearing assembly as shown in FIG. 1 or used in a pillow block bearing housing.

As illustrated in FIG. 3, the housing 12 is sized, shaped, and arranged to be mounted in the mechanical apparatus so the housing substantially encloses the roller bearing 14 in a protected interior cavity 30. The housing 12 is a two-piece assembly having a bearing enclosure 32 and a shaft receiving member 34. The bearing enclosure member 32 and the shaft receiving member 34 are each made from metal or other suitable material. The shaft receiving member 34 fastens to the bearing enclosure member 32 to form the housing 12. More specifically, the shaft receiving member 34 has a flange that adjoins an end surface of the bearing enclosure member 32. The bearing enclosure member 32 includes mounting feet 36 configured to mount the bearing assembly 10 on the mechanical apparatus where the housing 12 is used. Although the illustrated housing is a two-piece construction, it will be understood that the housing 12 may have other configurations without departing from the scope of the invention. In general, suitable bearing assembly housings will have an interior cavity for receiving a bearing and a shaft opening for receiving a rotatable shaft.

The housing 12 has the interior cavity 30, which is sized, shaped, and arranged to receive the bearing 14. As illustrated, the bearing enclosure member 32 of the housing 12 defines a radially inward facing bearing seat 40 for holding the bearing 14 to prevent it from moving transverse to a central axis A of the bearing or axially away from the shaft receiving member 34. The shaft receiving member 34 includes an axial face 42 configured to engage the bearing 14 and inhibit the bearing from moving axially in the housing 12. The interior cavity 30 is in fluid communication with a lubricant source (not shown) via an inlet 44 (FIG. 1) to provide lubricant to the bearing 14. The inlet 44 of some assemblies is connected to an automatic lubrication system to periodically supply lubricant to the interior cavity 30 of the housing 12. The interior cavity 30 of the housing 12 is substantially filled with lubricant during operation to minimize wear on the bearing 14. Further, the lubricant may be pressurized to prevent contaminants from entering the interior cavity 30 through the opening 18 during operation.

The opening 18 in the housing 12 extends between the interior cavity 30 and the exterior of the housing. In the illustrated housing 12, the shaft receiving member 34 defines the opening 18. The opening 18 is sized and shaped to receive a portion of the shaft 16 permitting the shaft to freely rotate in the opening. The shaft receiving member 34 of the illustrated assembly 10 includes an axially extending collar 46 that surrounds a larger diameter portion of the shaft outside of the interior cavity 30. A small clearance is provided between the collar 46 and the shaft 16 to inhibit contaminants from entering the interior cavity 30.

The housing 12 is configured to mount the seal 20 adjacent the opening 18 between the interior cavity 30 and the exterior of the housing. A radially inward facing seal mounting surface 50 sized for receiving the seal 20 is provided in the housing 12 to secure the seal in the proper position relative to the shaft opening 18. As illustrated, the shaft receiving member 34 of the housing 12 includes the seal mounting surface 50, but in other embodiments the seal mounting surface may be included in other portions of the housing without departing from the scope of the invention.

As further shown in FIG. 3, the bearing 14 supports the shaft 16 for rotation relative to the housing 12. The bearing 14 includes an outer race 52 mounted in the bearing seat 40. As shown in the drawings, the outer race 52 also engages the axial face 42 of the shaft receiving member 34 to position the bearing 14 axially in the housing 12. An inner race 54 centered on a central axis A of the bearing 14 freely rotates within the outer race 52. The inner race 54 is an annular body that extends around the shaft 16. The inner race 54 is mounted on the shaft 16 rotate with the shaft. The bearing 14 includes a plurality of rolling elements 56 positioned between the races 52, 54. As the inner race 54 rotates in the outer race 56 about the central axis A of the bearing 14, the rolling elements 56 roll along the inward facing surface of the outer race and the outward facing surface of the inner race to permit the inner race to freely rotate inside the outer race. The rolling elements 56 are preferably configured and arranged to inhibit the inner race 54 from moving parallel to the central axis A. Although the illustrated bearing 14 is a double row spherical roller bearing, those skilled in the art will appreciate that other types of bearings may be used without departing from the scope of the present invention.

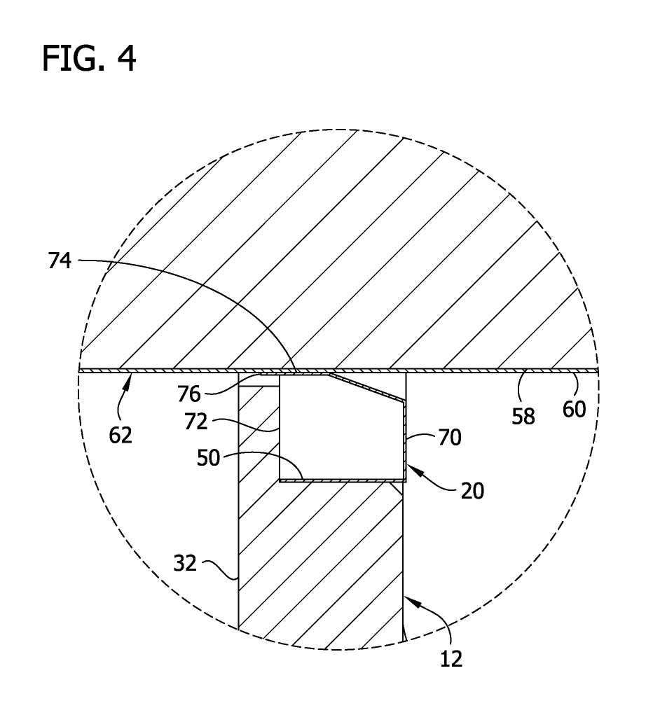

As shown in FIG. 4, the shaft 16 extends through the opening 18 in the housing 12 without contacting the housing. The shaft 16 has a radially outward facing surface 58 extending along the shaft from the interior cavity 30 of the housing 12 to the exterior of the housing. The outward facing surface 58 of the shaft 16 faces opposite the seal mounting surface 50 of the shaft receiving member 34 when the shaft extends through the shaft opening 18. As shown, the outward facing surface 58 of the shaft 16 is an annular surface oriented substantially parallel to the central axis of the bearing 14. The shaft 16 extends through the seal 20 without contacting the seal. As will be discussed in greater detail below, the radially outward facing surface 58 is spaced from the seal 20 in a configuration that directs fluid between the seal and the shaft 16 outward away from the interior cavity 30 and toward the exterior of the housing 12.

The inner race 54 of the bearing 14 receives the shaft 16 for rotation relative to the housing 12 about the center axis A. In some cases, the inner race 54 of the bearing 14 is press fit on the shaft 16 so the shaft rotates mutually with the inner race about the central axis. Some shafts 16 include a thin sleeve 60 overlying the outward facing surface 58 of the shaft the sleeve is axially aligned with the seal 20 to provide a suitable surface for contacting the seal 20 to reduce shaft wear and increase the useful life of the shaft. In some instances, the sleeve 64 is a SPEEDI-SLEEVE® shaft sleeve available from SKF USA Inc., which is a Delaware corporation having place of business in Lansdale, Pa. As will be appreciated by those skilled in the art, the outward facing surface 58 of the shaft 16 or that of the sleeve 60, when present, forms a sealing land or diameter, generally designated 62.

The seal 20 has a one piece annular body that is mounted on the sealing diameter 62 of the outward facing surface 58 of the shaft 16 and positioned axially between the interior cavity 30 of the housing 12 and the exterior of the housing to inhibit contaminants from entering the interior cavity and damaging the bearing 14. As shown in FIG. 4, the seal 20 includes an annular body having a bearing side 70, which faces the bearing 14 and the interior cavity 30 of the housing 12, and an opening side 72, which faces opposite the bearing when the seal is installed in the bearing assembly 10. The seal 20 also includes an inner surface 74 facing the radially outward facing surface 58 of the shaft 16. Together the inner surface 74 of the seal 20 and the outward facing surface 58 of the shaft 16 define an interface 76 between the shaft and the seal.

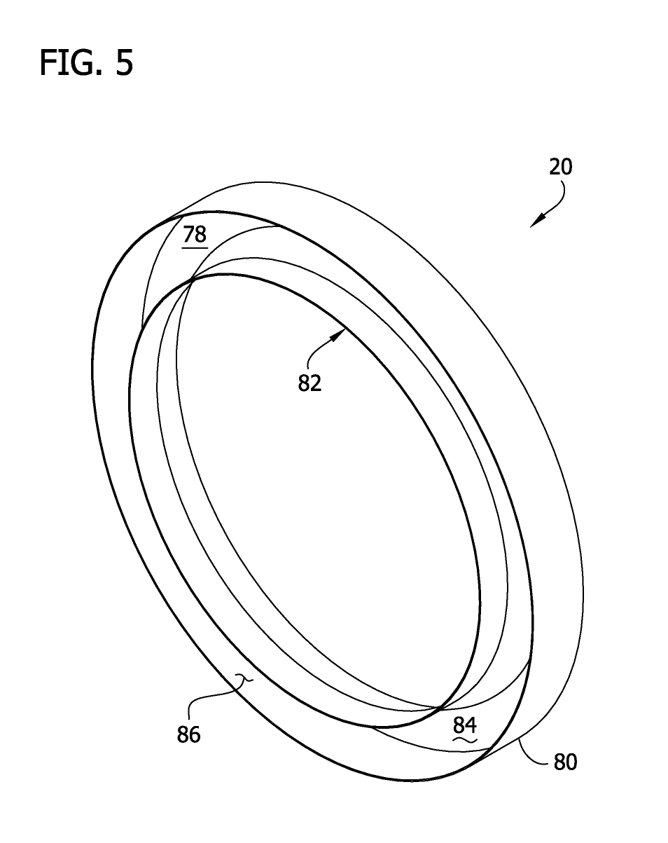

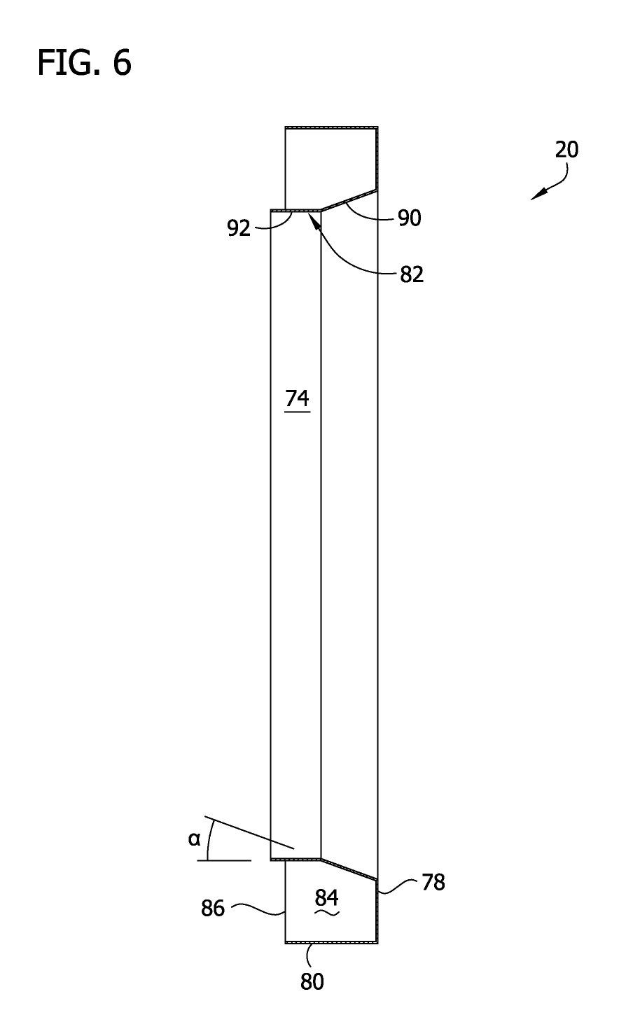

Referring to FIGS. 5 and 6, the seal 20 includes a radial section 78 extending between an inner end or boundary and an outer end or boundary. An outer axial section 80 extends from the outer boundary of the radial section 78 and an inner axial section, generally designated by 82, extends from the inner boundary of the radial section. The radial section 78, outer section 80, and inner section 82 define an annular space 84 in the seal 20. Both the outer section 80 and the inner section 82 extend from the radial section 78 toward the opening side 72 so the annular space 84 extends to an opening 86 in the opening side of the seal 20. As shown in FIG. 4, the outer section 80 of the illustrated seal 20 is fitted (e.g., press fit) on the seal diameter 62. The inner axial section 82 includes the inner surface 74, which faces the shaft 16 when installed in the bearing assembly 10. The inner surface 74 includes a tapered portion 90 having a predetermined axially varying radius that decreases from the bearing side 70 toward the opening side 72.

As further shown in FIGS. 5 and 6, the inner surface 74 also includes an axially extending sealing portion 92 having an inner diameter corresponding to the sealing diameter 62 of the shaft 16. The sealing portion 92 of the inner surface 74 of the seal 20 is sized to form a sealing interface with the sealing diameter 62. This sealing interface supports tribological film lubrication when the shaft 16 rotates relative to the housing 12 but contacts the shaft when the shaft is stationary relative to the housing. Thus, when the shaft 16 is rotating, the seal 20 supports a thin lubricant film to reduce shaft wear. Further, lubricant pressure inside the interior cavity 30 of the housing 12 and the tribological film prevent contaminants from entering the interior cavity of the housing through the interface. However, when the shaft 16 is stationary, the seal 20 contacts the shaft to prevent contaminants from entering the interior cavity 30 of the housing 12 through the interface. The radial section 78, the outer axial section 80, and the inner axial section 82 of the illustrated seal 20 have a uniform thickness, but it is envisioned the seal may have varying thicknesses without departing from the scope of the present invention. Although the seal 20 may be sized differently, in some instances the seal is sized such that it contacts the shaft 16 with a pressure of about 30 ounces per inch when the shaft is stationary. Although the sealing portion 92 of the inner surface 74 of the seal 20 may have other axial lengths, the illustrated seal has an axial length great than about ¼ inch. Further, in some cases the seal 20 comprises a material having a hardness compared to that of the sleeve 64 selected so the seal contacts the shaft with a pressure of at least about 15 ounces per inch when the shaft is stationary. Although the seal 20 may be made from other materials, in some cases the seal is 1100 aluminum alloy, a 5000 series aluminum alloy, or a material having a modulus of elasticity of less than about 10,000 ksi. Although the sleeve 64 may be made from other materials, in some instances the sleeve is stainless steel to provide a hardness difference sufficient to provide a service life of at least about 60,000 hours. Further, as will be appreciated by those skilled in the art, the surface roughness of the sleeve 64 and the seal 20 may be selected to provide a lambda ratio of more than about one. This ratio results in a suitable lubricant film thickness to prevent the seal 20 from contacting the shaft 16 as the shaft rotates inside the seal. As will be appreciated by those skilled in the art, lambda ratio is the ratio of the fluid film thickness to the composite surface roughness.

Referring to FIG. 6, the illustrated tapered portion 90 of the inner surface 74 of the seal 20 is sloped at an angle α in a range of about 20° to about 60° relative to the central axis A of the bearing 14. It is believed the sloped portion 90 may be sloped at other angles relative to the central axis A without departing form the scope of the present invention.

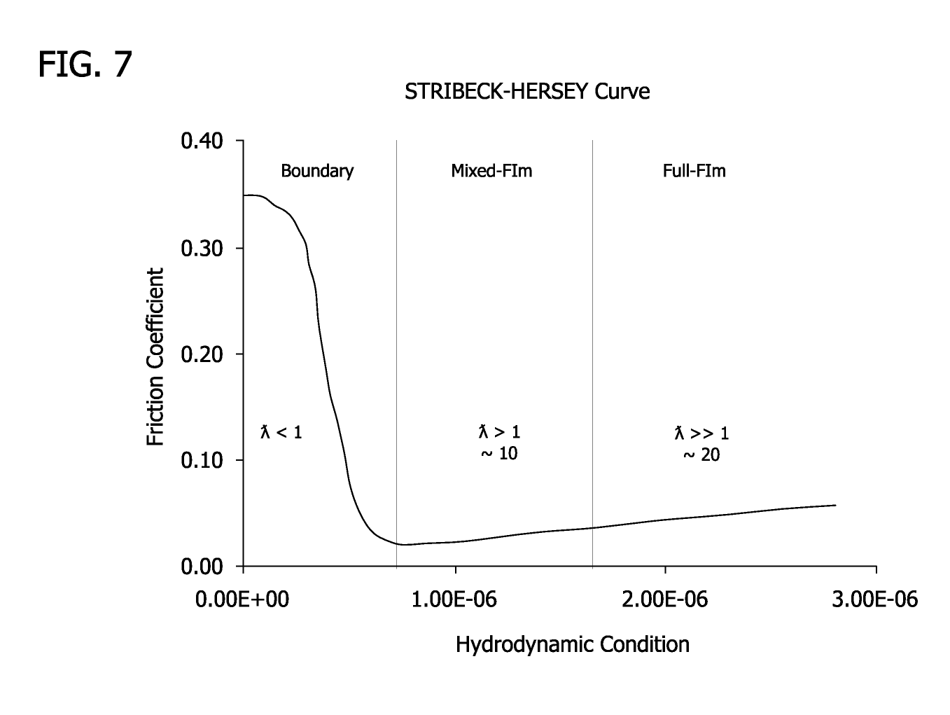

FIG. 7 is a Stribeck-Hersey curve illustrating exemplary frictional characteristics for a lubricant film formed between a rotating shaft and a bushing. This curve may be used to explain characteristics of a lubricant film between the sealing portion 92 of the seal 20 and the sealing diameter 62 of the shaft 16. The Stribeck-Hersey curve illustrates a friction coefficient (i.e., (friction force)/(normal force)) as a function of a lubrication film parameter (i.e., (viscosity)*(relative sliding speed)/(normal force)). As shown in FIG. 8, the curve is separated into three regimes, a boundary regime, a mixed-film regime, and a full-film regime. The boundary regime occurs when the lambda ratio (i.e., (fluid film thickness)/(composite surface roughness)) is less than one. The mixed-film regime occurs when the lambda ratio is greater than one (e.g., about ten). The full-film regime occurs when the lambda ratio is much greater than one (e.g., about twenty). FIG. 8 illustrates that when the rotation shaft speed is low, there is no or little film between a bushing and a shaft. As the speed increases for a given viscosity and load, the lubricant film increases and the friction is reduced significantly.

Most lubrication specialists agree that friction may be at its highest level during the boundary lubrication regime at startup, low speed, or high load conditions. The boundary lubrication regime occurs when asperities of two lubricated surfaces are in physically contact and moving relative to each other. This condition presents a potential for abrasion and/or adhesion. Because friction is high in the boundary lubrication regime, wear is believed to be more likely in this regime. Accordingly, lubrication engineers and tribologists have suggested that as much as seventy percent of wear occurs during machinery startup.

Generally speaking, the boundary lubrication regime is dramatically reduced as lubricant flow increases and the lubricant film becomes thicker between the surfaces in motion. As film thickness increases, the potential for asperity contact is reduced and the coefficient of friction drops dramatically through a condition known as mixed lubrication. As the lubricant film thickness increases, the system moves into the full film or hydrodynamic lubrication regime. During the hydrodynamic lubrication regime, such as when a full film of lubricant completely separates a turbine shaft from its support, there is little risk of asperity contact and the viscosity of the lubricant is sufficient to support the shaft and lubricate the support. During the full hydrodynamic lubrication regime, friction between the surfaces is extremely low, and for all practical purposes, non-existent. What little friction that is present is primarily in the lubricant itself, as the molecular structures of the lubricant shear during operation.

In view of the foregoing, it can be seen that a seal of relatively simple construction can be used to seal the housing opening of a bearing assembly around a shaft. Further, an inner surface of the seal 20 may be sized to support a tribological lubricant film when the shaft 16 rotates but to contact the shaft when stationary to prevent contamination and water from entering the housing.

Having described the invention in detail, it will be apparent that modifications and variations are possible without departing from the scope of the invention defined in the appended claims.

When introducing elements of the present invention or the preferred embodiment(s) thereof, the articles “a”, “an”, “the”, and “said” are intended to mean that there are one or more of the elements. The terms “comprising”, “including”, and “having” are intended to be inclusive and mean that there may be additional elements other than the listed elements.

As various changes could be made in the above constructions, products, and methods without departing from the scope of the invention, it is intended that all matter contained in the above description and shown in the accompanying drawings shall be interpreted as illustrative and not in a limiting sense.

What is claimed is:

1. A bearing assembly, comprising:
a housing having an interior cavity adapted to hold a lubricant, an opening extending from the interior cavity to an exterior of the housing, an inward facing seal mounting surface, and an inward facing bearing seat;
a bearing positioned in the interior cavity of the housing having a central axis, said bearing including an outer race mounted in the inward facing bearing seat of the housing and an inner race centered on the central axis and freely rotatable in the outer race;
a shaft mounted in the inner race of the bearing for rotation with the inner race about the central axis of the bearing, said shaft having an outer surface extending along the shaft from the interior cavity through the opening to the exterior of the housing, at least part of the outer shaft aligned with the opening having a sealing diameter; and
a seal mounted in the seal mounting surface of the housing and around the outer surface of the shaft, the seal being positioned axially along the shaft between the interior cavity of the housing and the exterior of the housing to inhibit contaminants from entering the interior cavity of the housing through the opening and damaging the bearing, the seal including an annular body having a bearing side facing the bearing, an opening side opposite said bearing side, and an inner surface facing the outer surface of the shaft, said inner surface having a tapered portion spaced from the outer surface of the shaft by a clearance gap having a predetermined axially varying width, said width of the clearance gap decreasing from the bearing side toward the opening side, and said inner surface including an axially extending sealing portion having an inner diameter corresponding to the sealing diameter of the outer surface of the shaft and forming a sealing interface with the outer surface of the shaft, said interface supporting tribological film lubrication when the shaft rotates relative to the housing to reduce shaft wear and contacting the shaft when the shaft is stationary relative to the housing to prevent contaminants from entering the interior cavity of the housing through the interface.

2. A bearing assembly as set forth in claim 1, wherein the seal contacts the shaft with a pressure of about 30 ounces per inch when the shaft is stationary relative to the housing.

3. A bearing assembly as set forth in claim 2, wherein the shaft includes a sleeve axially aligned with the seal to reduce shaft wear.

4. A bearing assembly as set forth in claim 3, wherein the seal comprises a material having a hardness compared to the sleeve selected so the seal contacts the shaft with a pressure of at least about 15 ounces per inch when the shaft is stationary relative to the housing for a life of at least about 60,000 hours.

5. A bearing assembly as set forth in claim 1, wherein the seal comprises 1100 aluminum alloy.

6. A bearing assembly as set forth in claim 1, wherein the seal comprises a 5000 series aluminum alloy.

7. A bearing assembly as set forth in claim 1, wherein the seal comprises a material having a modulus of elasticity less than about 10,000 ksi.

8. A bearing assembly as set forth in claim 1, wherein the shaft includes a sleeve axially aligned with the seal to reduce shaft wear.

9. A bearing assembly as set forth in claim 1, wherein the seal has a lambda ratio of greater than about one when the shaft rotates relative to the housing to prevent the seal from contacting the shaft.

10. A bearing assembly as set forth in claim 1, wherein the annular body of the seal comprises a radial section extending between an inner boundary and an outer boundary, an outer axial section extending axially from the outer boundary of the radial section, and an inner axial section extending axially from the inner boundary of the radial section, said inner axial section including said inner surface.

11. A bearing assembly as set forth in claim 10, wherein the outer axial section and inner axial section extend toward the opening side of the annular body of the seal.

12. A bearing assembly as set forth in claim 10, wherein the radial section, the outer axial section, and the inner axial section have a uniform thickness.

13. A bearing assembly as set forth in claim 10, wherein the sealing portion has an axial length of at least about ¼ inch.

14. A seal for use in a bearing assembly having a housing, a bearing positioned in the housing, a shaft mounted in the bearing for rotation and having a radially outward facing surface extending through an opening in the housing, said seal comprising an annular body having a bearing side adapted for facing the bearing when installed in the bearing assembly, the body having an opening side opposite said bearing side, and an inner surface facing the outer surface of the shaft, said inner surface having a tapered portion spaced from the outer surface of the shaft by a clearance gap having a predetermined axially varying width, said width of the clearance gap decreasing from the bearing side toward the opening side, and said inner surface including an axially extending sealing portion having an inner diameter corresponding to the sealing diameter of the outer surface of the shaft and forming a sealing interface with the outer surface of the shaft, said interface supporting tribological film lubrication when the shaft rotates relative to the housing to reduce shaft wear and contacting the shaft when the shaft is stationary relative to the housing to prevent contaminants from entering the interior cavity of the housing through the interface.

15. A seal as set forth in claim 14, wherein the seal contacts the shaft with a pressure of about 30 ounces per inch when the shaft is stationary relative to the housing.

16. A seal as set forth in claim 15, wherein the seal comprises a material having a hardness compared to the sleeve selected so the seal contacts the shaft with a pressure of at least about 15 ounces per inch when the shaft is stationary relative to the housing for a life of at least about 60,000 hours.

17. A seal as set forth in claim 14, wherein the seal comprises 1100 aluminum alloy.

18. A seal as set forth in claim 14, wherein the seal comprises a 5000 series aluminum alloy.

19. A seal as set forth in claim 14, wherein the seal comprises a material having a modulus of elasticity less than about 10,000 ksi.

20. A seal as set forth in claim 14, wherein the seal has a lambda ratio of greater than about one when the shaft rotates relative to the housing to prevent the seal from contacting the shaft.

21. A seal as set forth in claim 14, wherein the annular body of the seal comprises a radial section extending between an inner boundary and an outer boundary, an outer axial section extending axially from the outer boundary of the radial section, and an inner axial section extending axially from the inner boundary of the radial section, said inner axial section including said inner surface.

22. A seal as set forth in claim 21, wherein the outer axial section and inner axial section extend toward the opening side of the annular body of the seal.

23. A seal as set forth in claim 21, wherein the radial section, the outer axial section, and the inner axial section have a uniform thickness.

24. A seal as set forth in claim 21, wherein the sealing portion has an axial length of at least about ¼ inch.

25. A seal for use in a bearing assembly having a housing, a bearing positioned in the housing, a shaft mounted in the bearing for rotation and having a radially outward facing surface extending through an opening in the housing, said seal comprising an annular body having a bearing side adapted for facing the bearing when installed in the bearing assembly and an opening side opposite said bearing side, the annular body comprising a radial section extending between an inner boundary and an outer boundary, an outer axial section extending axially from the outer boundary of the radial section, and an inner axial section extending axially from the inner boundary of the radial section, said inner axial section having an inner surface adapted for facing the shaft when installed in the bearing assembly, said inner surface including a tapered portion having a predetermined axially varying radius, said radius decreasing from the bearing side toward the opening side, and said inner surface including an axially extending sealing portion having an inner diameter corresponding to the sealing diameter of the outer surface of the shaft and forming a sealing interface with the outer surface of the shaft, said interface supporting tribological film lubrication when the shaft rotates relative to the housing to reduce shaft wear and contacting the shaft when the shaft is stationary relative to the housing to prevent contaminants from entering the interior cavity of the housing through the interface.

26. A seal as set forth in claim 25, wherein the outer axial section and inner axial section extend toward the opening side of the annular body of the seal.

27. A seal as set forth in claim 25, wherein the radial section, the outer axial section, and the inner axial section have a uniform thickness.

28. A seal as set forth in claim 25, wherein the sealing portion has an axial length of at least about ¼ inch.
